(19) United States
(12) Patent Application Publication
(10) Pub. No.: US 2005/0160072 A1
(43) Pub. Date: Jul. 21, 2005

(54) System and method for providing a condition update and for fulfilling needs of a profile subject

(76) Inventor: Allison Ricciardi, Huntington, NY (US)

Correspondence Address: DILWORTH & BARRESE, LLP, 333 EARLE OVINGTON BLVD., UNIONDALE, NY, 11553, US

(21) Appl. No.: 11/039,491

(22) Filed: Jan. 20, 2005

Related U.S. Application Data
(60) Provisional application No. 60/537,759, filed on Jan. 20, 2004.

(51) Int. Cl. G06F 7/00

(52) U.S. Cl. 707/1

(57) ABSTRACT

There is provided a system for providing a condition update and for fulfilling needs of a profile subject, including a computer system containing at least one database for storing condition information of at least one profile subject and needs information of the at least one profile subject, inputting by a first party the condition information and the needs information of the at least one profile subject, and accessing the condition information and fulfilling needs of the at least one profile subject based on the needs information by a second party.

### PRIORITY

This application claims the benefit of U.S. Provisional Application No. 60/537,759, filed Jan. 20, 2004, the contents of which are hereby incorporated by reference.

### BACKGROUND OF THE INVENTION

1. Field of the Invention

The present invention relates generally to a system and method for providing a condition update and for fulfilling needs of a profile subject.

2. Description of the Related Art

Wherever there is a patient, there are also many needs the patient and his or her family requires to be fulfilled. These needs arise regardless of whether the patient is in a hospital, rehabilitation center, or at home. Some of these needs may include child care, driving other children to and from sports or other events, meals to be prepared, food shopping, pet care, house cleaning, attaining of medical/surgical supplies, financial needs, etc. And depending on the length and severity of the patient's injuries and condition, the list can be overwhelming. Local friends and relatives may be able to meet some of these needs, provided they are aware of them. More distant friends and relatives may want to help, but their distance provides an obstacle that is often unable to be surmounted.

In addition to the needs of the patient and family, there is the endless outpouring of good will by those calling to determine the physical condition of the patient. Although always well intentioned, the large volume of telephone calls from relatives and friends inquiring about the patient's condition can often become overwhelming. Fielding a continuous stream of telephone calls in this manner can often create additional stress for the patient and those supplying care.

### SUMMARY OF THE INVENTION

There is a longstanding need to fulfill the needs of a patient or profile subject and to inform friends or visitors of changes in conditions in a simple and non-intrusive manner.

It is, therefore, an object of the present invention to provide a system and method for fulfilling the needs of a profile subject and/or family.

It is a further object of the present invention to provide a system and method for providing updated condition information relating to the physical condition of a profile subject.

It is still a further object of the invention to provide a system and method for fulfilling the needs of a profile subject and/or family, and for providing updated condition information relating to the physical condition of a profile subject.

To achieve the above and other objects, there is provided a system for providing a condition update and for fulfilling needs of a profile subject, including a computer storage system containing a first database for storing condition information of at least one profile subject, and a second database for storing needs information of the at least one profile subject; a first user terminal connected to the computer storage system for providing and updating the condition information and the needs information of the at least one profile subject; and a second user terminal connected to the computer storage system for at least one of accessing the condition information and fulfilling needs of the at least one profile subject based on the needs information.

There is also provided a method for providing a condition update and for fulfilling needs of a profile subject via a computer based system, including storing condition information of at least one profile subject; storing needs information of the at least one profile subject; providing and updating the condition information and the needs information of the at least one profile subject; and accessing the condition information and fulfilling needs of the at least one profile subject based on the needs information.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a Internet based computer system to which the present invention is applied; and

FIG. 2 is a block diagram illustrating the interaction between various databases as provided by the preferred embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

In order to address the problems existing in the prior art, the present invention has been created. In general terms, the present invention solves the problems in the prior art by providing a system that creates a profile subject account, stores profile subject information in a database associated with the profile subject's account, and provides access to that stored information to other people. The system can be sized to accommodate various numbers of profile subject accounts. In order to provide current information, the profile subject information is updated on a regular basis. Throughout this application the person who initially inputs and updates a profile subject's information will be referred to as the profile manager. In the preferred embodiment, one profile manager is given access to each profile subject account. Other people are prevented from full access to a profile subject account through the use of usernames and passwords. The profile manager can be a family member, a friend, or other person given the task of maintaining the profile subject account. The profile manager is given special access to all of the profile subject's information. The profile manager inputs profile subject information, condition information and needs information into the system. The system stores the information in various databases. Other people are then granted limited access to the profile subject account, i.e. the profile subject information, the condition information and the needs information. The other people who access the information will be referred to herein as visitors. Access by the visitors can be controlled by the use of access levels, usernames and passwords. Two access levels are provided, a public access level and a private access level. The editor sets the access level for each bit of information input into the system. When a visitor decides on a particular need to fulfill, the visitor is directed to an input screen to input needs fulfillment information.

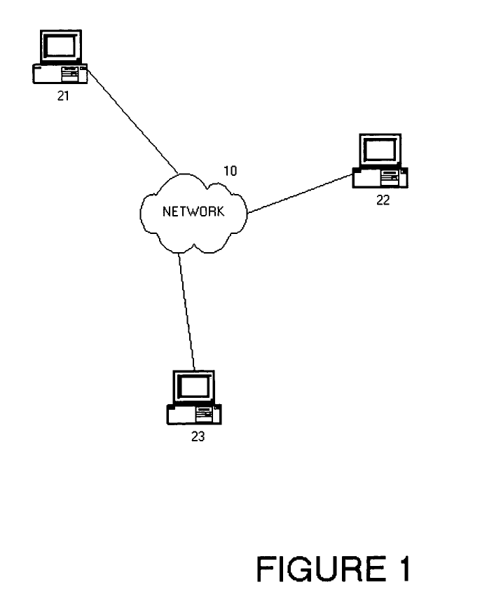

FIG. 1 is a block diagram illustrating an Internet based computer system to which the present invention is applied. Shown in FIG. 1 are server 21, profile manager terminal 22, and user terminal 23, all connected via network 10. The server 21 contains the profile subject information and is accessed by the profile manager terminal 22 through network 10. In the preferred embodiment the network 10 is realized through the Internet, and as such, a website and web pages are used as the interface for the profile manager terminal 22 and the user terminal 23 to access the server 21. Visitors use a user terminal 23 to access the profile subject information contained in the server 21 also through network 10. The profile manager terminal 22 and the user terminal 23 can be the same terminal. And, although only one user terminal 23 is depicted in FIG. 1, it is to be understood that any number of user terminals can exist in the preferred embodiment. The above-described terminals can be personal computers, personal digital assistants (PDAs), cellular telephones, etc.

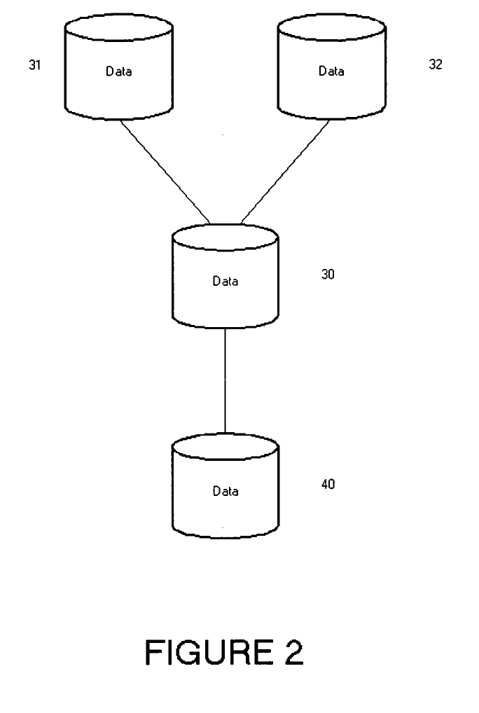

FIG. 2 is a block diagram illustrating the interaction between various databases as provided by the preferred embodiment of the present invention. Shown in FIG. 2 are profile subject information database 30, condition database 31, needs database 32 and visitors database 40. In the preferred embodiment all of these databases are included in the server. It is also understood that although the databases in FIG. 2 are shown as separate entities, in practice the databases can all be contained in a single storage device. Each profile subject account contains a profile subject information database 30, a condition database 31, a needs database 32 and a visitors database 40.

The profile subject information database 30 stores personal information of the profile subject. This personal information can include, but is not limited to, the name of the profile subject, the profile subject's address, telephone number, and other identifying features of the profile subject. Identifying information related to the profile manager can also be stored in the profile subject information database 30. The profile manager information is primarily used to identify the profile manager.

The condition database 31 stores the condition related information of each profile subject. The profile manager, through the profile manager terminal 22, enters the condition related information of the profile subject and the server 21 stores the information in the condition database 31. The profile manager should update the condition related information a regular basis in order to provide up-to-date condition information of the profile subject.

The needs database 32 stores the individual needs that require fulfilling. The profile manager enters needs information of the profile subject (or the profile subject's family), and the server 21 stores the needs information in needs database 32. As old needs are filled or are no longer required and as new needs arise, the profile manager should update the needs information.

The visitors database 40 stores information related to visitors to the profile subject account. After the profile manager completes the setup of the profile subject account, i.e. after the profile subject information, the condition information and the needs information is initially input, visitors are then invited to the website to access the profile subject account. The invitation to the visitor can be provided by the server 21 itself when an profile manager inputs email addresses of visitors. The email invitation would include an Internet address to a web page that will provide the visitor with an opportunity to set up a visitors account. The visitor's account is set up by entering a preset amount of personal information, which is stored in the visitors database 40, for example, a name and an email address. After the visitor's account is set up the visitor creates a username and password that will be used to access the particular profile subject account. Of course, the above invitation example is but one method, and other known website invitation methods can be used and are contemplated.

Once a visitor has been invited to the website and creates a username and a password, the visitor can log onto the website and access the profile subject account. The access granted to the visitor is set to one of a public access level or a private access level. Once the visitor logs onto the website the visitor can then review the condition information of the profile subject to receive a condition update, and depending on the access level granted to the visitor, can either view public or private access level condition and needs information.

As stated earlier, the needs database 32 stores needs information of the profile subject. The needs can include money, house cleaning services, catering services or frozen meals, toys, books, magazines, home health aides or equipment, medical supplies, car services, toys, pajamas, etc. The profile manager is provided with lists of optional needs suggestions that he can choose from, and is also provided with the ability to add other items to the needs database 32 of the profile subject account. The visitor views the listed needs of the profile subject and is provided the ability to select one or more of the needs to fulfill. The visitor is then provided with the ability to email the profile manager to request permission to fulfill the selected need. For example, a local visitor, Visitor X, may decide to fulfill a “drive son to soccer practice on Thursday” need listed on the profile subject account. Visitor X selects the item, and after, the server 21 provides Visitor X with an email screen to input a request to fulfill the selected need. The server 21 then sends an email to the profile manager containing the request. The profile manager then replies to the email to notify Visitor X whether or not to fulfill the need. If fulfilled, the need “drive son to soccer practice on Thursday” can then be removed, by the profile manager from the needs list. Visitor X could then be emailed a reminder to fulfill the need.

As an additional feature of the system, a visitors mailing list is setup by the profile manager. This mailing list is used by the server 21 to automatically generate and send an email notifying those on the mailing list each time the profile subject account is updated by the profile manager. The e-mail provides a link back to the website for access to the latest information. This also increases traffic flow to the site and consequently increases advertising revenue as well.

For those in need of financial assistance, separate donation finds for individual cases can be set up, with the money going directly to the profile subject and not through large organizations with costly overhead. Of course a small handling fee can be collected to maintain the funds accounts. Electronic funds transfers via the Internet are well known in the art and will not be described herein.

It is also contemplated that the above-described service will be free to users and would be funded by advertisers on the site. Commissions are generated when these advertisers sell items through the site. For example, links to relevant charities and foundations (e.g. American cancer Society, American Heart Association, Cystic Fibrosis, etc.) can be provided for information or to make donations. Additionally, links to certain needs or gifts can also be provided such as links to florists, magazine subscription services, local cleaning services, etc.

In addition to illness and injury cases, the website is useful to those who have suffered natural disasters and setbacks (for example, victims of fires or hurricanes), hospital patients, persons confined to their home, those having difficult pregnancies or multiple births, crisis pregnancy cases, adoption updates, those in the active military, etc. Each of these different “profile subjects” can set up a profile subject account to provide updates and seek the fulfillment of needs.

For more public cases, such as those in the news, a public password is initially provided for the public to access the profile subject account, but each public access level visitor is requested to create a visitor account, i.e. create a username and password, to offer assistance and fulfill needs, but with more private information given only to visitors that have been invited and have a password clearance for private level access.

As another aspect of the present invention, an “Adopt a Family” section is also available in cases of large-scale disasters like the wildfires of California, etc. The dislocated families can set up an account and visitors can provide for the needs of the dislocated family.

While the invention has been shown and described with reference to a certain preferred embodiment thereof, it will be understood by those skilled in the art that various changes in form and details may be made therein without departing from the spirit and scope of the invention as defined by the appended claims.

1. A system for providing a condition update and for fulfilling needs of a profile subject, comprising:
a computer system containing at least one database for storing condition information of at least one profile subject and needs information of the at least one profile subject;
means for inputting by a first party the condition information and the needs information of the at least one profile subject;
means for accessing by an at least one second party the condition information and the needs information of the at least one profile subject; and
means for fulfilling by the at least one second party the needs of the at least one profile subject based on the needs information.

2. The system of claim 1, wherein at least one of the inputting and the accessing is done via the Internet.

3. The system of claim 1, further comprising an email server for automatically generating and sending an email to the at least one second party when at least one of the condition information and the needs information is updated.

4. The system of claim 1, wherein different access levels are granted to the first party and the at least one second party.

5. The system of claim 4, wherein the access levels are password protected.

6. A system for fulfilling needs of a profile subject, comprising:
a computer system containing a database for storing needs information of the at least one profile subject; and
a user terminal connected to the computer system for inputting by a first party the needs information of the at least one profile subject, and for accessing by at least one second party the needs information of the at least one profile subject.

7. The system of claim 6, wherein the at least one second party fulfills a need of the at least one profile subject based on the needs information.

8. The system of claim 6, further comprising a second user terminal connected to the computer system for accessing by the at least one second party the needs information of the at least one profile subject.

9. The system of claim 8, wherein at least one of the first terminal and the second terminal is connected to the computer system via the Internet.

10. The system of claim 9, further comprising an email server for automatically generating and sending an email to the at least one second party when at least one of the condition information and the needs information is updated.

11. The system of claim 8, wherein the first party inputs condition information of the at least one profile subject, and the at least one second party accesses the condition information of the at least one profile subject.

12. The system of claim 6, wherein different access levels are granted to the first party and the at least one second party.

13. The system of claim 12, wherein the access levels are password protected.

14. A method for fulfilling needs of a profile subject via a computer based system having a memory to store information, including the steps of:
inputting by a first party needs information of at least one profile subject; and
accessing by at least one second party the needs information of the at least one profile subject.

15. The method of claim 14, further comprising the steps of:
inputting by the first party condition information of the at least one profile subject; and
accessing by the at least one second party the condition information of the at least one profile subject.

16. The method of claim 14 further comprising the step of fulfilling by the at least one second party needs of the at least one profile subject based on the needs information.

17. The method of claim 14, wherein the storing and the accessing are conducted via the Internet.

18. The method of claim 15, further comprising the steps of automatically generating and sending an email to the at least one second party when at least one of the condition information and the needs information is updated.

19. The system of claim 14, different access levels are granted to the first party and the at least one second party.

20. The system of claim 19, wherein the access levels are password protected.
